(19) United States
(12) Patent Application Publication
(10) Pub. No.: US 2010/0140427 A1
(43) Pub. Date: Jun. 10, 2010

(54) Toll transponder holder for motor cycles

(76) Inventor: John Myers, Kirkland, IL (US)

Correspondence Address: Charles F. Lind, 2210 E. Sherwood Road, Arlington Hts., IL, 60004, US

(21) Appl. No.: 12/315,612

(22) Filed: Dec. 5, 2008

(51) Int. Cl. A47B 96/06; G08G 1/065

(52) U.S. Cl. 248/214; 340/928

(57) ABSTRACT

The disclosed bracket has bottom and side walls configured to define an open top channel sized to removably receive with limited side clearance a toll transducer until resting against the bottom wall. An opening or break in one of the side walls exposes the operative face of the transducer. A tab formed off a bracket wall is used to secure the bracket to a vehicle, typically a motorcycle, with the operative face of the transponder positioned forwardly. The positioned transponder can sense a toll charging signal from an authorizing toll collecting transmitter. A successful signal connection with a cash rich transponder will thus provide payment of the needed vehicle toll. The vehicle operator need not hold or handle the transponder during toll payments, making this arrangement particularly advantageous for use on motorcycles, where two hand motorcycle operations might be preferred.

### BACKGROUND OF THE INVENTION

Many roadway systems impose tolls on vehicles using the system, collecting such tolls at spaced locations along the roadway. Tolls can be collected automatically, using a transmitter mounted over or next to the roadway that emits a signal effective to electronically deduct a needed toll from a funded transponder carried on the passing vehicle.

The typical portable transponder has a hard plastic case approximately 3½″ by 3″ by ½″. The transponder can be secured by Velcro hook-loop connectors, or other means, to the rear side of the transparent vehicle windshield, allowing the transmitter signal to pass through the windshield and deduct the needed toll, as the vehicle passes the transmitter.

In vehicles having enclosed cabs, the transponder can be left mounted in a locked vehicle cab, safe from thief and adverse weather, while yet being positioned ready for exposure to the signaling toll transmitter. However, a transponder mounted on an open unattended motorcycle could be exposed to both adverse weather and the possibility of being stolen.

As a consequence, motorcycle riders frequently treat the transponder as portable, storing it in a locked compartment or carrying it when off the motorcycle, and exposing it when riding the cycle past the signaling transmitter. Cycle riders can expose the transponder in different ways, such as by tapping it to his/her clothing or helmet, by carrying it in a chest pocket, or by manually exposing it each time needed.

### OBJECTS OF THE INVENTION

A basic object of the invention is to provide a bracket for removably but securely holding a portable money charged transponder on a motorcycle or like open vehicle, in proper position to be scanned by toll collecting signals from a signaling transmitter.

A more detailed object of the invention is to provide a bracket that can be easily and firmly secured to the motorcycle without damaging the same, the bracket defining a channel for receiving a toll paying transponder and holding it in proper position to receive and respond to a toll collecting signal from a transmitter at a toll station, and the bracket also allowing easy removal of the transponder when desired, as when the motorcycle might be left unattended.

### SUMMARY OF THE INVENTION

This invention relates to a bracket adapted to be mounted on a motorcycle, suited for removably but securely holding a money charged transponder appropriately positioned to be scanned by a toll collecting transmitter signal for paying a needed toll, without the rider reaching for and/or holding and/or re-pocketing the transponder in any distracting manner. The bracket can be mounted to the motorcycle handlebar by a conventional “P” clip, or to a conventional motorcycle windshield using the same bolt holding the windshield together. The bracket can be economically stamped of steel.

### BRIEF DESCRIPTION OF THE DRAWINGS

These and other objects, advantageous and features of the invention will be more fully understood and appreciated after considering the following description of the invention, that includes the accompanying drawings, wherein:

FIG. 1 is a frontal perspective view of the inventive toll transponder bracket;

FIG. 2 is a top plan view of the bracket, showing portions of a typical transponder carried therein;

FIG. 3 is a rear elevation view of the bracket, again showing portions of a transponder carried therein;

FIG. 4 is a section view as seen from line 4-4 in FIG. 3, again showing portions of a transponder carried therein;

FIG. 5 is a forward looking perspective view of a motorcycle, showing a bracket mounted on its handlebar, showing also a toll transponder inserted in the bracket;

FIG. 6 is a sectional view as taken generally from line 6-6 in FIG. 5;

FIG. 7 is a perspective view like FIG. 5, except showing the motorcycle with a windshield having a transponder bracket mounted thereon, and showing a transponder just outside of the bracket, in an inserting or removing position; and

FIG. 8 is a sectional view as taken generally from line 8-8 in FIG. 7.

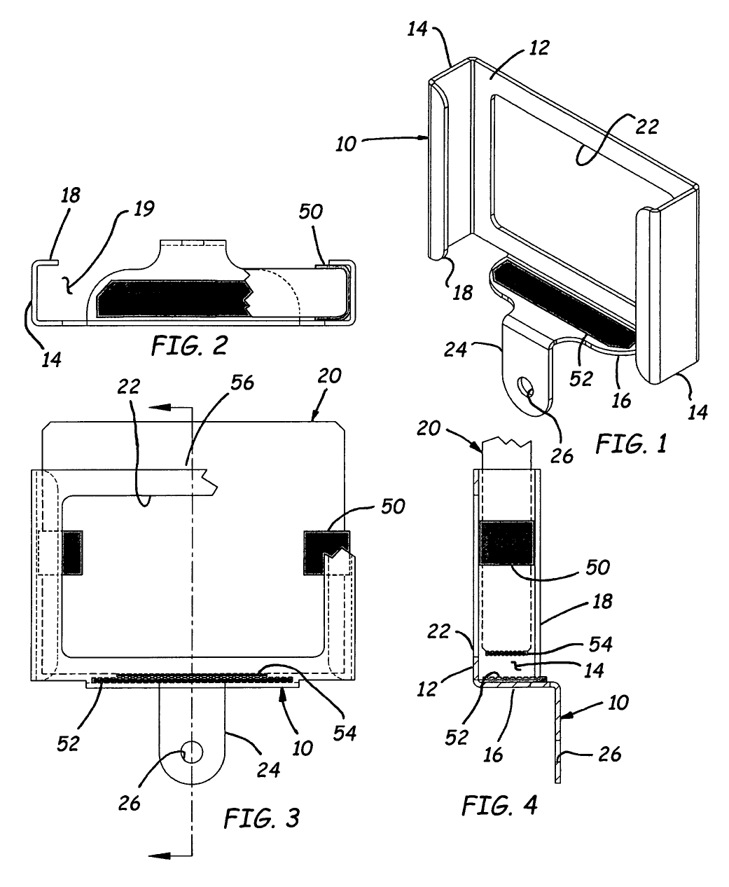

### DETAILED DESCRIPTION OF THE INVENTION

The illustrated one-piece bracket 10 has an intermediate rear wall 12, and two side walls 14 and a bottom wall 16 projected forwardly off the rear wall, with short stub walls 18 formed inwardly off of the front ends of the side walls 14 and disposed generally parallel to the rear wall. The walls 12, 14 and 18 are configured and spaced to define a top open generally rectangular cavity or channel 19 sized to receive and laterally hold, with minor peripheral side clearances, a typical toll transponder 20. The intermediate rear wall 12 has a central opening 22, for reducing the bracket weight and for providing easy gripping of both sides of the transponder when positioned in the bracket.

Further, a short tab 24 is projected laterally off the front end of the bottom wall 16, in the direction away from transponder cavity 19. A tab hole 26 provides for cooperating with a nut and bolt assembly 28 (FIG. 6) or bolt 29 (FIG. 8) for connecting the bracket 10 to the motorcycle.

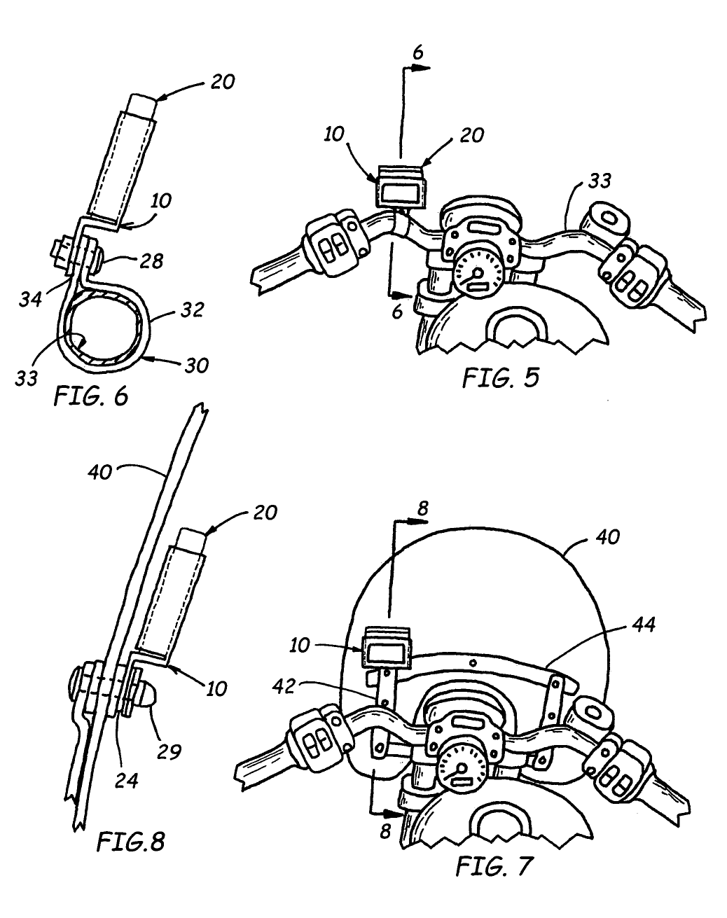

FIGS. 5 and 6 illustrate a “P” clip 30 having an intermediate band 32 sized to fit almost around the motorcycle handlebar 33, terminating at adjacent side by side end legs 34 that lie adjacent the bracket tab 24. The bracket tab 24 and band ends 34 have openings for accepting the bolt of the assembly 28. When the band is sized properly and the nut and bolt assembly 28 is tightened, the clip 30 firmly holds the bracket 10 on the motorcycle handlebar 33.

The transponder 20, when inserted into and carried in the bracket channel 19, is almost completely exposed through the open bracket front between the short stub walls 18, suited to respond to a toll collecting signal from an operating transmitter (not shown) when passing a toll collecting station (not shown).

Alternatively, FIGS. 7 and 8 illustrate how the bracket tab 24 can be directly connected to the rear side of the motorcycle windshield 40. More specifically, vertical and horizontal mounting bars 42, 44 are secured against the front side of the windshield 40 by bolts 29 extended from the front side thereof through openings in the windshield and threaded into a nut 45 held against the rear side of the windshield. The bracket tab is shown tightened against the rear side of the windshield 40, using the same bolt 29 that connects the mounting bars 42, 44 and windshield 40 together

The bracket 10 can be permanently left connected to the motorcycle, orientated with the receiving channel 19 opening upwardly suited to receive and hold the transponder 20. This vertical orientation allows gravity to help retain the transponder in the channel.

An annular rubber or fibrous washer 48 can be interposed between the bracket tab 24 and windshield 40, reducing possible scratching of the windshield.

Narrow strips 50 of Velcro loop connectors can be secured around the corners of the side, front and rear faces of the transponder 20, at locations to fit into the bracket 10 to be near the top edge thereof. The strips 50 effectively cushion the transponder 20 in a snug manner in the bracket 10 and reduce transponder vibration against the bracket.

Further, a narrow strip 52 of a Velcro hook connector can be bonded to the bottom bracket wall 16 and a narrow strip 54 of a Velcro loop connector can be bonded to the bottom of the transponder. Thus, when the bracket 10 is fully inserted into the channel 19, the Velcro strips 52, 54 engage to secure the transponder 20 firmly therein. However, the transponder can be intentionally removed from the bracket merely by pulling it outwardly or upwardly with a force sufficient to overcome this Velcro strip securing force.

The bracket 10 can be sized vertically smaller than the height of the transponder 20, so that the upper portion of the transponder will project beyond the upper edge 56 of the bracket. This allows pinch gripping of the transponder 20 for easier manual insertion into or removal of the transponder relative to the bracket channel.

As should now be understood, the disclosed bracket 10 can be easily secured to the motorcycle, suited to portably mount and hold a toll paying transponder 20 operatively in place thereon. This allows two hand control of the motorcycle when passing through a toll collecting station. The transponder will be fully exposed to the transmitted collection signals when passing through a toll station, allowing for the automatic deduction of the needed toll from the transducer.

The bracket 10 having the illustrated shape and construction can be a one-piece stamping of a durable but formable metal, such as steel. To yield an appealing appearance, the metal bracket can be painted black or with colors matching popular motorcycle colors, or can be chrome plated so as to match the other chromed motorcycle parts. Alternatively, the brackets 10 can be molded of plastic, in black or other appropriately colored plastic, or can be painted, to match popular motorcycle colors.

While a single embodiment of the bracket has been illustrated, changes could be made without departing from the inventive teaching. Accordingly, the invention is to be limited only by the following claims.

What is claimed is:

1. A one-piece bracket for removably holding a toll transponder relative to an open vehicle, such as a motorcycle, comprising bottom and side walls defining an open top channel sized to receive said toll transponder with limited side clearance until supported against the bottom wall, means for securing the bracket to the vehicle with the channel upwardly directed and said toll transponder forwardly facing and exposed through an opening in the adjacent bracket side wall, suited to respond to toll collecting signals emitted from a forwardly located transmitter, and means to hold the toll transponder stably within the bracket channel.

2. A bracket according to claim 1, wherein said means for securing the bracket to the vehicle includes a short tab formed off of the bottom wall suited to be firmly secured to the vehicle.

3. A bracket according to claim 2, further comprising said tab having an opening therein whereby a bolt extended through said tab opening can be secured to the vehicle for securing the bracket to the vehicle.

4. A bracket according to claim 3, further comprising said means to hold the toll transponder stably within the bracket include hook and loop Velcro components respectively secured to the bottom bracket wall and to the bottom of the transponder, to provide that with the Velcro components engaged, the transponder will be held in the bracket.

5. A one-piece bracket according to claim 4, further with said means for securing the bracket to the vehicle including a “P” connector clip fitted around the motorcycle handlebar, and a nut and bolt assembly cooperating to hold the connector clip and bracket tab together.

6. A one-piece bracket according to claim 4, further having a windshield mounted on the front of the motorcycle, said windshield having vertical and horizontal bars secured thereto by bolts extended through openings in the bars and windshield, and said means for securing the bracket to the motor cycle provides that one of the windshield securing bolts is also fitted through the tab opening as the bracket is positioned on the rear side of the windshield.

7. A bracket according to claim 3, further comprising said means to hold the toll transponder stably within the bracket include hoop and loop Velcro components respectively secured to the bracket bottom wall and to the bottom of the transponder, providing with the Velcro components engaged to hold the transponder in the bracket.

8. A one-piece bracket for removably holding a toll transponder relative to a motorcycle, comprising a rear wall, spaced side walls projecting forwardly off the rear wall and spaced front stub walls projecting off of the side walls, the rear, side and front stub walls being properly spaced apart to define an open top channel sized to receive said toll transponder with limited clearance, and a bottom wall projecting forwardly off the rear wall suited to underlie and support said toll transponder, a short tab angled downwardly off of the front of the bottom wall, means for securing the tab to the vehicle with the channel upwardly open and said toll transponder facing forwardly and largely exposed between the front stub walls, allowing toll collecting signals emitted from a forwardly located transmitter to strike against the positioned transponder and complete proper toll collection, and hoop and loop Velcro components respectively secured to the bracket bottom wall and to the bottom of the transponder, providing with the Velcro components engaged to stably hold the toll transponder within the bracket channel.

9. A bracket according to claim 8, further comprising narrow strips of Velcro loop connectors secured around the side corners of the transponder at locations to fit against the bracket rear, side and front stub walls for cushioning the transponder in the bracket.

10. A bracket according to claim 9, further comprising said tab having an opening therein whereby a bolt extended through said tab opening can be secured to the vehicle for securing the bracket to the vehicle.
